(19) United States
(12) Patent Application Publication
(10) Pub. No.: US 2015/0007300 A1
(43) Pub. Date: Jan. 1, 2015

(54) METHOD, APPARATUS, AND SYSTEM FOR USING IC CARD AS AUTHENTICATION MEDIUM

(71) Applicant: ELECTRONICS AND TELECOMMUNICATIONS RESEARCH INSTITUTE, Daejeon (KR)

(72) Inventors: Soo-Hyung KIM, Daejeon (KR); Seok-Hyun KIM, Daejeon (KR); Seung-Hyun KIM, Daejeon (KR); Jong-Hyouk NOH, Daejeon (KR); Sang-Rae CHO, Daejeon (KR); Young-Seob CHO, Daejeon (KR); Jin-Man CHO, Daejeon (KR); Seung-Hun JIN, Daejeon (KR); Dae-Seon CHOI, Daejeon (KR); Hyun-Sook CHO, Daejeon (KR)

(73) Assignee: ELECTRONICS AND TELECOMMUNICATIONS RESEARCH INSTITUTE, Daejeon (KR)

(21) Appl. No.: 14/319,412

(22) Filed: Jun. 30, 2014

(30) Foreign Application Priority Data
Jul. 1, 2013 (KR) 10-2013-0076554
May 29, 2014 (KR) 10-2014-0065285

(51) Int. Cl. G06F 21/33

(52) U.S. Cl. CPC G06F 21/33
USPC 726/9; 455/41.1

(57) ABSTRACT

Provided are management and use of an authentication medium, and specifically, to an apparatus and method for registering and using an IC card as an authentication medium in a user terminal. An apparatus for using the IC card as the authentication medium includes an ID extracting module configured to extract identification information from the IC card that performs near field communication with a user terminal; an ID checking module configured to determine whether the extracted identification information matches identification information of the IC card that is previously registered as an authentication medium; and a security service module configured to provide a security service interface for a security service provided by the determined IC card.

### CROSS-REFERENCE TO RELATED APPLICATION

This application claims priority to and the benefit of Korean Patent Application Nos. 10-2013-0076554, filed on Jul. 1, 2013 and 10-2014-0065285, filed on May 29, 2014, the disclosures of which are incorporated herein by reference in their entirety.

### BACKGROUND

1. Field of the Invention

The present invention relates to management and use of an authentication medium, and specifically, to an apparatus and method for registering and using an IC card as an authentication medium in a user terminal.

2. Discussion of Related Art

Recently, an IC card has been actively progressing as a secure storage medium of personal information. IC card technology for public use such as an electronic passport and an electronic resident card was developed and most cash cards and credit cards are being converted into IC cards. Also, the IC card is widely used as a physical access control device in companies and public offices. This is due to technological advantages in that it is difficult to maliciously delete or modify IC card information issued to users and it is possible to conveniently read user information stored in the IC card. Therefore, users receive several IC cards for various reasons, and use services (such as account management/withdrawal, payment, and access control) provided in a specific environment (such as ATM and POS) prepared by IC card issuers and relevant operators.

However, using the IC card in an open environment such as a user terminal is not widespread yet. As the latest technology in this field, an IC card installed in a cellular phone, that is, a secure element (SE) such as a UICC (USIM card), is used. Some electronic wallets that are recently introduced by many makers provide a mobile payment service using such an SE. However, such latest technology has a limitation of securing a variety of services. The number of IC cards that can be installed in the user terminal is very limited (for example, one to three). Restricting applications that can use the IC card for security is one factor to limit service expansion.

In addition, basically, the IC card installed in the user terminal makes it vulnerable to leakage of important personal information through terminal hacking, malicious applications, and the like without the user's awareness, and attacks (for example, IC card locking) that disable use of the IC card itself. Therefore, it is not easy to prepare measures that may cope with various external risks.

### SUMMARY OF THE INVENTION

In view of the problems in the related art, the present invention provides an apparatus and method capable of storing authentication information such as an authentication certificate in an IC card separately provided from a user terminal and using such an IC card as an authentication medium in the user terminal.

According to an aspect of the present invention, there is provided an apparatus for using an IC card as an authentication medium. The apparatus includes an ID extracting module configured to extract identification information from the IC card that performs near field communication with a user terminal; an ID checking module configured to determine whether the extracted identification information matches identification information of the IC card that is previously registered as an authentication medium; and a security service module configured to provide a security service interface for a security service provided by the determined IC card.

The ID extracting module may include identification information extracting command codes with respect to at least one specification of a plurality of standardized IC card specifications and private IC card specifications.

The ID extracting module may determine whether the IC card is compliant with an IC card specification that can be used as the authentication medium, execute the identification information extracting command codes corresponding to the determined card specification, and extract identification information from the IC card.

When registration of the IC card as the authentication medium is requested from a user, the ID extracting module may store the extracted identification information in a memory of the user terminal or a secure element coupled to the user terminal.

When registration of the IC card as the authentication medium is requested from a user, the ID extracting module may deliver the extracted identification information to a card management server to be managed by the card management server.

When use of a security service of the IC card is requested from a user, the ID checking module may determine whether the extracted identification information matches identification information that is previously stored in a memory of the user terminal or a secure element coupled to the user terminal.

When use of a security service of the IC card is requested from a user, the ID checking module may deliver the extracted identification information to a card management server, and request determination on whether the extracted identification information matches identification information that is previously stored in the card management server.

The apparatus may further include a user authentication module configured to transmit user authentication information obtained from the user terminal to the IC card when user authentication is requested from the IC card.

The apparatus may further include a terminal authentication module configured to transmit terminal authentication information generated by the user terminal to the IC card when user terminal authentication is requested from the IC card.

According to another aspect of the present invention, there is provided an authentication system that uses an IC card as an authentication medium. The system includes an IC card; a user terminal configured to extract identification information from the IC card, register the IC card as an authentication medium, and use a security service provided by the registered IC card; and a card management server configured to determine whether the IC card is registered as the authentication medium or the IC card is already registered as the authentication medium using identification information extracted from the IC card.

The user terminal may include a near field communicating unit configured to perform near field communication (NFC) with the IC card; a memory configured to store an application program requiring the security service and an IC card manager program that provides the security service required by the application program using the IC card registered as the authentication medium; and a processor configured to execute the application program and the IC card manager program stored in the memory. The IC card manager program may include instructions for extracting identification information from the IC card; determining whether the extracted identification information matches identification information of the IC card that is previously registered as the authentication medium; and providing a security service interface for the security service provided by the determined IC card.

According to still another aspect of the present invention, there is provided a method of using an IC card as an authentication medium. The method includes requesting that a user bring an IC card to be registered as an authentication medium in contact with a user terminal; determining whether the IC card in contact with the user terminal has an IC card specification that can be registered as the authentication medium; extracting identification information from the IC card that has registrable IC card specification by executing identification information extracting command codes corresponding to the IC card specification; and storing the extracted identification information in either a memory of the user terminal or a secure element (SE) coupled to the user terminal, or transmitting the extracted identification information to a card management server to be stored in the card management server.

The method may further include transmitting terminal authentication information of the user terminal to the IC card to be stored in the IC card.

When the user wants to use the IC card registered as the authentication medium, the method may further include requesting that a user bring an IC card registered as the authentication medium in contact with the user terminal; extracting identification information from the contacted IC card by executing an identification information extracting command codes corresponding to the registered IC card specification; determining whether the extracted identification information matches identification information of the IC card that is registered as the authentication medium; and using a security service provided by the determined IC card.

The method may further include transmitting terminal authentication information of the user terminal to the IC card when authentication of the user terminal is necessary to use the security service provided by the IC card.

The method may further include transmitting user authentication information of the user to the IC card when authentication of the user is necessary to use the security service provided by the IC card.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram schematically illustrating an authentication system for using an IC card as an authentication medium according to an embodiment of the present invention;

FIG. 2 is a diagram illustrating a detailed configuration of an IC card manager installed in a user terminal according to an embodiment of the present invention;

FIG. 3 is a flowchart illustrating a process of registering an IC card as an authentication medium according to an embodiment of the present invention;

FIG. 4 is a flowchart illustrating a process of using an IC card registered as an authentication medium according to an embodiment of the present invention;

FIG. 5 illustrates an exemplary screenshot of registering an IC card according to an embodiment of the present invention;

FIG. 6 illustrates an exemplary screenshot of electrically signing using an IC card according to an embodiment of the present invention; and

FIG. 7 illustrates an exemplary screenshot of a case in which update of a certificate previously stored in an IC card is failed according to an embodiment of the present invention.

### DETAILED DESCRIPTION OF EXEMPLARY EMBODIMENTS

While the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

In description of the invention, when it is determined that detailed descriptions of related well-known technology may unnecessarily obscure the gist of the invention, detailed descriptions thereof will be omitted.

In addition, the singular forms used in the specification and claims are interpreted to include plural forms as well, unless otherwise indicated.

Terms used in the specification such as “module,” “unit,” and “interface,” generally refer to computer related objects, and may refer to, for example, hardware, software, and combinations thereof.

Recently, most user terminals (such as a smartphone and a tablet) adopt a near field communication (NFC) function by default. Therefore, the present invention uses an NFC-enabled IC card in which an authentication certificate is installed as an authentication medium for authentication required for a user terminal. For this purpose, the present invention needs to address the following problems.

(1) The user terminal is able to identify and use an IC card having an authentication certificate installed therein and a service provided by the IC card.

(2) Since the IC card may be lost, it is necessary to prevent a malicious user from using an IC card having another user's authentication certificate installed therein.

(3) It is necessary to block a malicious terminal from attacking an IC card having an authentication certificate installed therein. The NFC-enabled IC card may be easily attacked from the outside in a public place in which contact with strangers is easy such as a subway even if the card is in a user's wallet.

(4) An authentication service needs to be conveniently used through the user's minimum manipulation. Since a user terminal serving as a service medium and an IC card serving as an authentication medium are separated and the IC card is used when the service is necessary, security is high but it is difficult to maintain and manage a connection session.

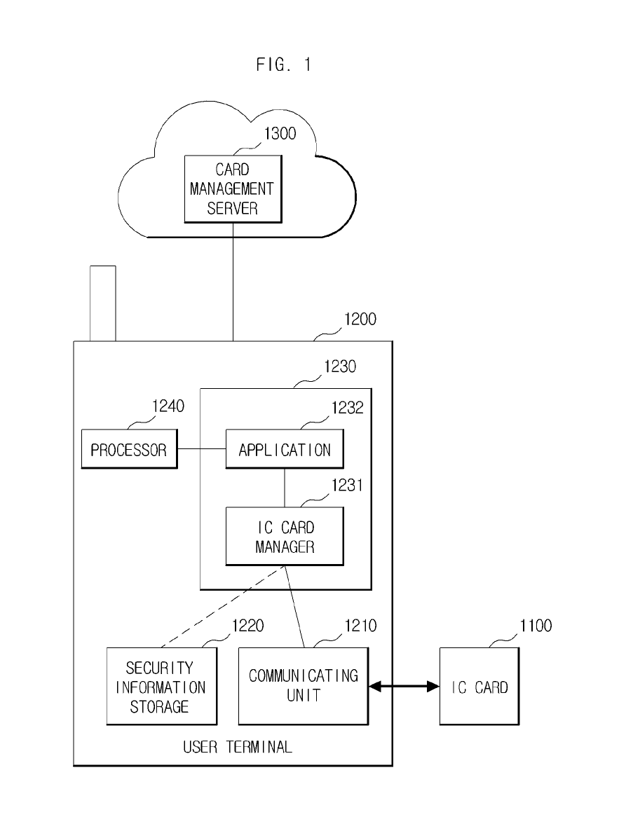

Hereinafter, embodiments of the present invention designed to address such problems will be described with reference to accompanying FIGS. 1 to 7. Description will be provided in detail, focusing on parts necessary for understanding operations and actions of the present invention.

FIG. 1 is a diagram schematically illustrating an authentication system for using an IC card as an authentication medium according to an embodiment of the present invention. As illustrated in FIG. 1, the authentication system may include an IC card 1100, a user terminal 1200, and a card management server 1300.

In one embodiment, the IC card 1100 is a contactless NFC-enabled IC card and may include a contactless card, a hybrid card, a combi card, and the like. Examples of the IC card may include a transportation card, a cash card, a credit card, an electronic passport, an electronic resident card, an employee ID (a student ID), and a certificate card, which are issued to the user for a variety of purposes. Also, a single IC card may provide a plurality of IC card specifications. For example, specifications of the transportation card, the credit card, and the employee ID (student ID) may be provided in a single IC card.

In the IC card 1100 used in the present invention, identification information (for example, a transportation card unique number, an account number, a credit card number, a passport number, a social security number, an employee number, and certificate identification information) may be extracted from the IC card 1100. In addition, the IC card may store security information such as an authenticate and a secret key in an internal memory, provide the information as necessary, and provide a security service such as key generation, authenticate storing and management, an electronic signature, OTP, and cross authentication.

The user terminal 1200 is the user's personal terminal such as a smartphone and a tablet and may be one of various types of NFC-enabled personal terminals. The user terminal 1200 is a device that can extract identification information from the IC card 1100, register the IC card as an authentication medium, and use the security service provided by the registered IC card.

It may include a near field communicating unit 1210, a security information storage 1220, a memory 1230, and a processor 1240.

The communicating unit 1210 performs NFC with the IC card.

The security information storage 1220 is a storage that stores the identification information of the IC card 1100 or stores terminal authentication information of the user terminal. It may be, for example, a secure element (hereinafter referred to as a “terminal SE”) coupled to a substrate of the user terminal.

The memory 1230 may store an IC card manager 1231 and an application 1232 executed by the processor 1240.

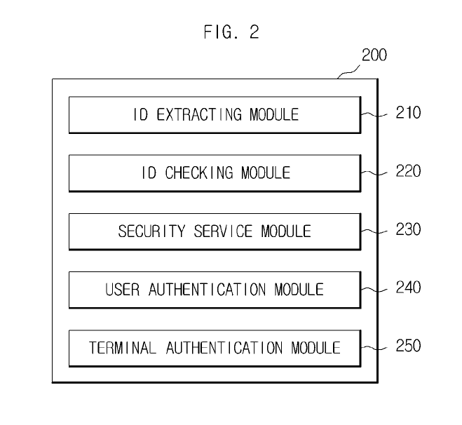

In one embodiment, the IC card manager 1231 may register the IC card 1100 to the user terminal 1200 as the authentication medium, and provide the security service provided by the registered IC card to the application 1232. The IC card manager 1231 is a library or a service process and can operate as a part of the application 1232 or as an independent process. The IC card manager 1231 may provide the security service required by the application 1232. The IC card manager 1231 will be described in detail with reference to FIG. 2.

The application 1232 is software that uses the security service provided by the IC card manager 1231. The application 1232 may include, for example, mobile banking, electronic wallet, online payment, and certificate management software that requires user identification, user authentication, an electronic signature, an authenticate management function, and the like.

The card management server 1300 uses the identification information extracted from the IC card to secondarily determine whether the IC card may be registered as the authentication medium, or determine whether the IC card is already registered as the authentication medium. For example, even if the IC card specification is a registrable card specification, the card management server 1300 may disallow a corresponding card to be registered as the authentication medium depending on card issuing companies.

Also, the card management server 1300 may provide security information (for example, public key/private key information) necessary for authentication (for example, terminal authentication), information update (for example, authentication certificate update), and information generation (for example, electronic signature generation) transaction between the user terminal 1200 and the IC card 1100.

In one embodiment, the card management server 1300 may include an authentication certificate management server, a financial institution server, and the like depending on the purpose of use of the IC card.

FIG. 2 is a diagram illustrating a detailed configuration of an IC card manager installed in a user terminal according to an embodiment of the present invention.

In one embodiment, an IC card manager 200 is software that operates when the user brings the IC card in contact with the user terminal. The IC card manager 200 may include at least one of an ID extracting module 210, an ID checking module 220, a security service module 230, a user authentication module 240, and a terminal authentication module 250.

The ID extracting module 210 extracts identification information from the IC card performing NFC with the user terminal.

In one embodiment, in order to extract the identification information from the IC card, the ID extracting module 210 may include an identification information command codes of at least one specification among domestically and internationally standardized IC card specifications (for example, a transportation card standard, a financial IC card standard, and a certificate-related standard) and/or private IC card (for example, an employee ID and a visiting ticket) specifications.

In one embodiment, the ID extracting module 210 determines whether the IC card in contact with the user terminal is compliant with an IC card specification that can be used as the authentication medium, and may extract the identification information from the IC card by executing identification information extracting command codes corresponding to the determined card specification.

In one embodiment, the ID extracting module 210 determines whether an application of a specific specification is installed in the IC card so that a specification of the corresponding IC card may be determined, which is possible when a fixed application ID (AID) is inquired of. For example, an application ID of a visa credit card installed in the IC card is “A0000000031010” and it may be determined that the visa credit card is installed in the IC card through the corresponding application ID.

In one embodiment, when registration of the IC card as the authentication medium is requested from the user, the ID extracting module 210 may store the extracted identification information in a memory of the user terminal 1200 or may store and manage the extracted identification information in the SE coupled to the user terminal (‘terminal SE’). In another embodiment, the ID extracting module 210 delivers the extracted identification information to the card management server 1300 to be managed by the server 1300.

When use of the security service of the IC card is requested from the user, the ID checking module 220 determines whether the identification information extracted by the ID extracting module 210 matches pre-stored identification information.

In one embodiment, the pre-stored identification information may be stored in the memory of the user terminal 1200 or in the SE. In this case, the ID checking module 220 compares the extracted identification information and the identification information stored in the memory or in the terminal SE and determines whether the information matches.

In another embodiment, the identification information may be stored in the card management server 1300. In this case, the ID checking module 220 delivers the extracted identification information to the card management server 1300, and may request determination on whether the extracted identification information matches the pre-stored identification information.

The security service module 230 provides a security service interface for using the security service (for example, save/delete/update/inquiry authentication information and an electronic signature) provided by the determined the IC card. For example, when the IC card provides a certificate-related security token service, a public-key cryptography standards (PKCS) #11 interface may be provided to use the service.

When user authentication is requested in order to receive the security service such as the electronic signature from the IC card, the user authentication module 240 may provide user authentication information obtained from the user terminal to the IC card when the user brings the IC card in contact with the user terminal. The IC card may perform user authentication using the user authentication information provided from the user authentication module 240.

When terminal authentication is necessary to extract the identification information from the IC card or receive the security service, the terminal authentication module 250 may provide terminal authentication information that is previously generated from the user terminal to the IC card when the user brings the IC card in contact with the user terminal.

In one embodiment, in order to obtain the terminal authentication information, the terminal authentication module 250 may generate authentication information using an API provided from the user terminal, receive the authentication information through the terminal SE, or receive the authentication information through the card management server. The terminal authentication information may be the same or different when the IC card is registered and when the IC card is used, which results from a terminal authentication mechanism, and the present invention is not limited thereto.

Meanwhile, since the IC card also has an authentication module, it is possible to determine the authentication information provided from the user terminal and provide the identification information and/or the security service to only the authenticated user terminal.

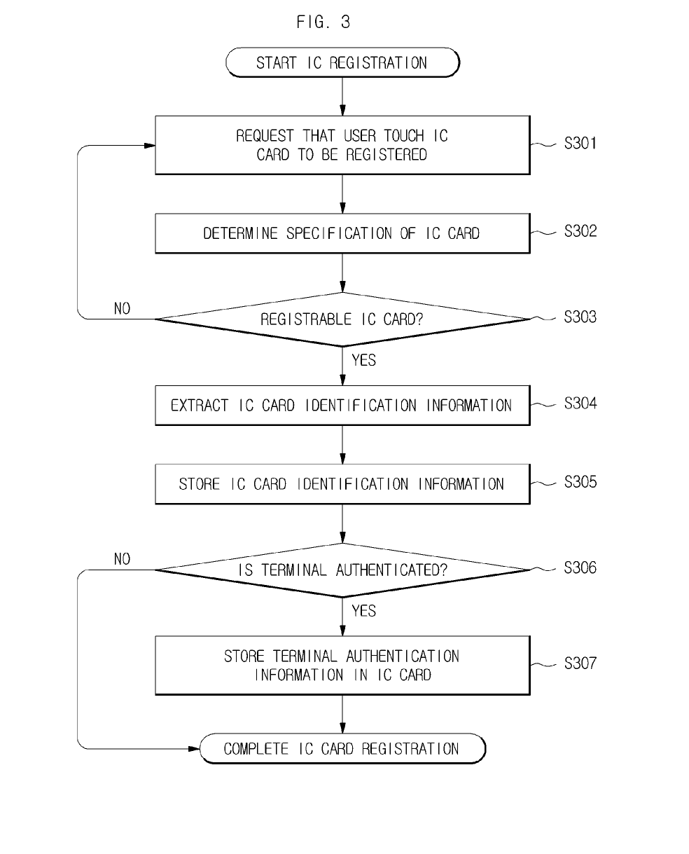

FIG. 3 is a flowchart illustrating a process of registering an IC card as an authentication medium according to an embodiment of the present invention. Specifically, according to the embodiment of the present invention, the process in which the user brings the IC card for using as the authentication medium or for receiving the security service in contact with the user terminal and identification information of the corresponding the IC card is extracted and registered is illustrated.

In S301, the application or the IC card manager requests that the user bring the IC card to be registered as the authentication medium in contact with the user terminal. In one embodiment, the application or the IC card manager may display a type of the IC card having a registrable specification on a terminal screen through a GUI for the user. In this case, the application may previously perform a procedure of communicating with the IC card to be contact with the user terminal using the IC card manager. For example, a specification module to be communicated with the IC card is loaded in advance (for example, load PKCS#11 library of a financial IC card security token) and thus a time for communicating with the IC card may be minimized.

The user brings the IC card to be registered in contact with the user terminal. In this case, the user may place the IC card in a range in which a communication module and the IC card can communicate such that the communication module of the user terminal recognizes the IC card. When the communication module recognizes the IC card, the application may communicate with the IC card.

In S302, the IC card manager determines whether the IC card in contact with the user terminal is compliant with IC card specifications (for example, a transportation card standard, a financial IC card standard, a certificate-related standard, and a private identification specification) that can be registered as the authentication medium. In one embodiment, by determining whether an application of a specific specification is installed in the IC card, it is possible to identify the specification of the IC card, which is possible when a fixed application ID (AID) is inquired of.

In S303, when it is unable to identify the specification of the IC card in contact with the user terminal or the identified specification of the IC card is not a registrable specification, the user is additionally requested to bring another IC card.

In S304, the IC card manager extracts the identification information from the IC card that is determined as a registrable card by executing identification information extracting command codes corresponding to the identified card specification. Formats and types of the identification information may be variously defined by the specification of the IC card. The procedure of extracting the identification information may also vary depending on the specification. In addition, the identification information may be formed of a combination of various pieces of information that are included in the IC card. For example, when the IC card of a certificate-related specification such as PKCS#11 is registered, at least one of an authenticate key ID and an owner name may be used as the identification information.

In S305, the IC card manager stores the extracted identification information in the memory of the user terminal or the terminal SE (for example, UICC). Alternatively, the extracted identification information may be transmitted to the card management server and managed by the card management server.

In one embodiment, in order to store the extracted identification information in the terminal SE, the IC card manager may need to perform a procedure of using the SE (for example, a UICC connection and a UICC applet selection) in advance.

In another embodiment, in order to store the extracted identification information in an IC card management server, the IC card manager may need to perform a process for using the IC card management server (for example, server connection, user account selection, and authentication) in advance.

Also, when the extracted identification information is stored in the IC card management server, the card management server may restrict registration of the identification information. The card management server may determine whether the IC card is a card that is included in a scope that needs to manage itself or coincides with a security policy using the identification information. For example, the determined specification and the identification information of the IC card are used to determine an issuing company of the IC card and then registration of a card of a specific company may be restricted.

Also, when the identification information of the IC card is used to determine user information, registration of the IC card may be restricted by checking whether a user of the user terminal matches a user of the IC card.

In S306, it is determined whether authentication of the user terminal is performed later in a process of communicating between the user terminal and the IC card.

When the terminal authentication is performed, terminal authentication information may be registered (stored) in advance in the IC card in S307. The IC card that has registered the terminal authentication information may perform terminal authentication for the user terminal that communicates with the IC card.

For example, the terminal authentication information may be a public key of the user terminal. When the public key of the user terminal is stored in the IC card, the IC card may request an electronic signature of any data from the user terminal to be communicated. The user terminal may provide electronically signed information to the IC card using the private key, and the IC card determines the provided electronically signed information using the registered public key to perform terminal authentication.

As another example, unique identification information of the user terminal may be registered as the terminal authentication information. Since another user terminal has difficulty in guessing and generating unique identification information of a specific user terminal, terminal unique identification information may be used as the terminal authentication information in a low-level security service.

In one embodiment, the terminal authentication information may be stored and managed in the terminal SE or the card management server, and delivered to the IC card. When the terminal SE or the card management server manages the terminal authentication information, terminal authentication may be normally performed even if the user terminal is replaced later.

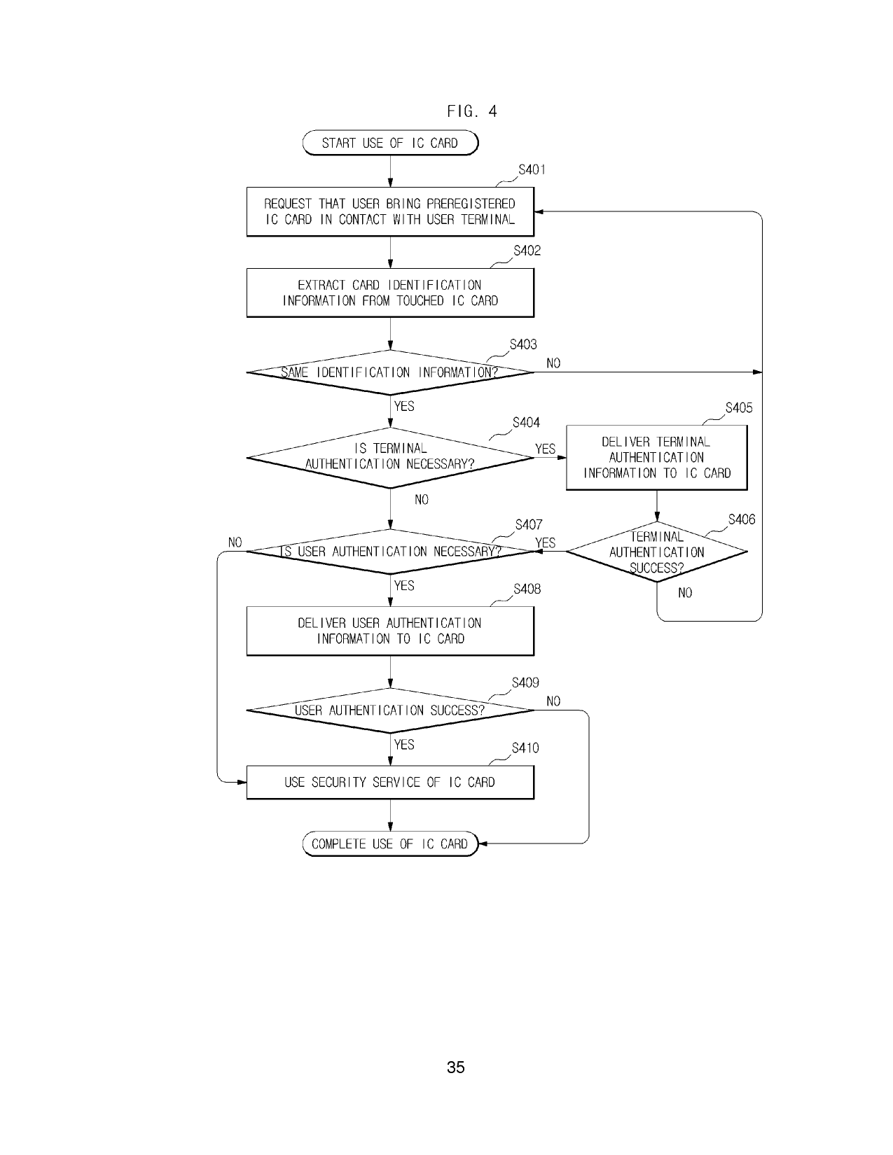

FIG. 4 is a flowchart illustrating a process of using an IC card registered as an authentication medium according to an embodiment of the present invention.

In S401, the application displays the IC card that is previously registered on a screen in a form of a GUI for the user and requests that the user bring a corresponding card. For example, when the registered IC card stores an authentication certificate of the user and provides an electronic signature service, owner information of the authentication certificate may be displayed. In this case, the owner information is extracted and stored during an operation of registering the IC card. In addition, the application may previously perform a procedure of communicating with the IC card to be contact with the user terminal using the IC card manager. For example, by previously loading a specification module to be communicated with the IC card (for example, load PKCS#11 library of a financial IC card security token) or previously receiving the authentication information, it is possible to minimize a time for communicating with the IC card.

The user brings the pre-registered IC card in contact with the user terminal. At this time, the user may place the IC card in a range in which the user terminal can communicate with the IC card such that the user terminal may recognize the IC card. The application may communicate with the IC card.

In S402, the IC card manager executes identification information extracting command codes corresponding to a specification of the pre-registered IC card and extracts identification information from the IC card touched by the user.

In S403, the IC card manager determines whether the extracted identification information matches identification information of the IC card that is previously registered as the authentication medium. When it is determined that the identification information is not the same, the user is requested to touch another IC card.

In S404, it is determined whether terminal authentication is necessary. When terminal authentication is necessary, the terminal authentication information may be transmitted to the IC card (S405). In this case, as the terminal authentication information, terminal authentication information generated when the IC card is registered, information associated with the generated terminal authentication information, or modified information thereof may be used.

It is determined whether terminal authentication of the IC card is successful (S406). When terminal authentication of the IC card is successful, the process advances to the following operation (S407), and otherwise, the user may be requested to touch another IC card.

In S407, it is determined whether user authentication is necessary. When user authentication is necessary, user authentication information may be transmitted to the IC card (S408). It is preferable that the user authentication information be obtained from the user before the IC card is touched. As the user authentication information, a PIN, a password, bio information, and the like may be used. The user authentication information may be previously stored when the IC card is issued such as a credit card, or authentication information may be input and registered by the user when the IC card of the present invention is registered.

Although FIG. 4 illustrates that user authentication is performed after the user terminal is authenticated, user authentication may be performed earlier than terminal authentication or user authentication and terminal authentication may be performed at the same time depending on implementation. For example, information generated by cryptographically combining the terminal authentication information with the user authentication information is provided to the IC card, and the IC card may cryptographically determine the provided information.

Next, in S409, when it is determined that user authentication of the IC card is successful, the user may use the security service provided by the IC card. In one embodiment, the security service provided by the IC card may include storage, inquiry, update, discarding of the authentication certificate, an electronic signature, and the like.

Meanwhile, storing of the security information (for example, an authentication certificate) necessary for the security service provided by the IC card may be performed during an operation of using the security service of the present invention (S410) through the security service (for example, a security token service) of the IC card, but the present invention is not limited thereto. Independently from the present invention, the security information may be previously stored in the IC card through an IC card issuing company system.

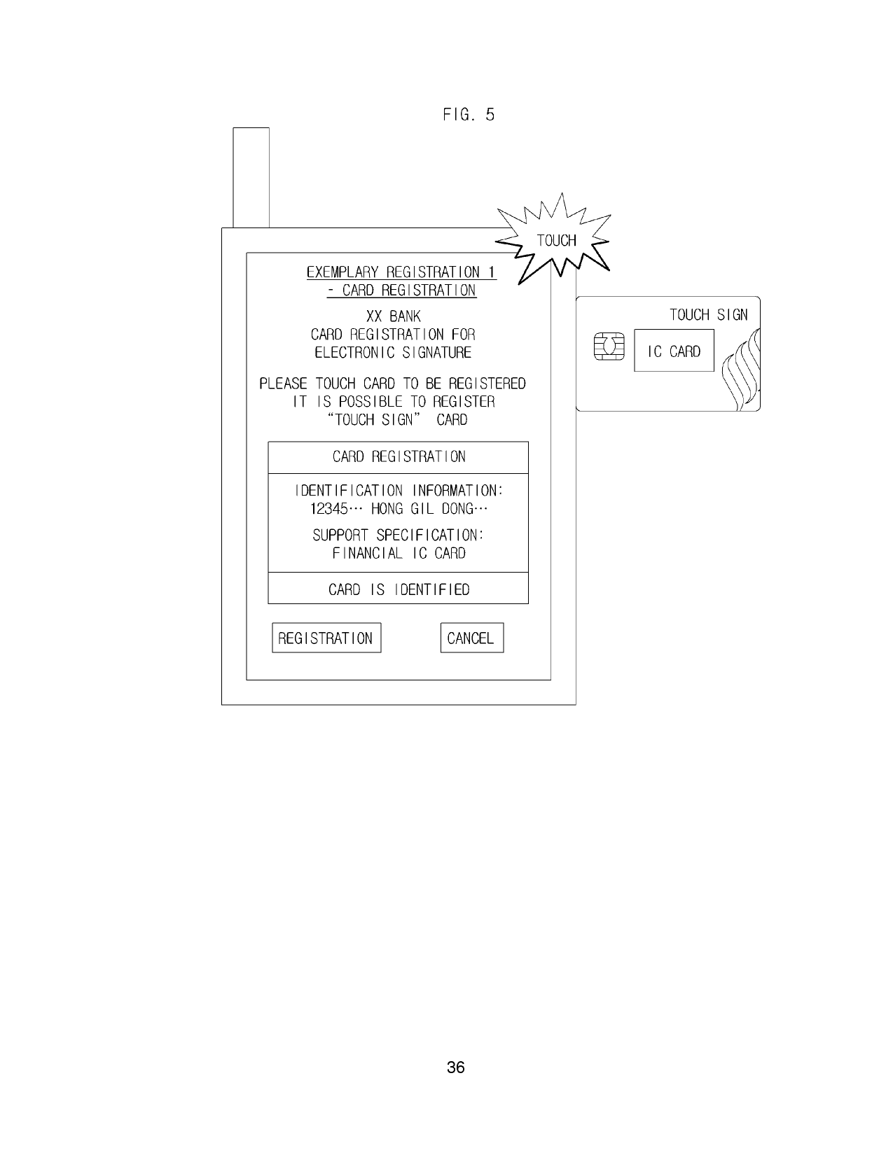

FIG. 5 illustrates an exemplary screenshot of registering an IC card according to an embodiment of the present invention. As illustrated in FIG. 5, the application may be mobile bank software. The mobile bank software may request that the user register a “touch sign” card (an IC card supporting a certificate-related IC card specification according to the present invention) for account transfer. When the user brings his or her “touch sign” card in contact with the user terminal, identification information extracted from the “touch sign” card, a specification supported by the “touch sign” card, and the like may be determined.

At this time, a part of the extracted identification information is output when the user's determination is necessary and may not be output when the user's determination is unnecessary. In one embodiment illustrated in FIG. 5, the identification information is partially output in order to determine owner information of the certificate stored in the IC card.

In addition, a part of the determined card specification is output when the user's determination is necessary and may not be output when the user's determination is unnecessary. Although detailed description of the specification is output in order to describe the present invention in FIG. 5, the application may provide the user with only notification on whether the card may be registered by determining a supporting specification and providing data of the IC card.

When the user clicks a registration button for the registrable IC card, a process of registering the IC card according to the present invention may be performed.

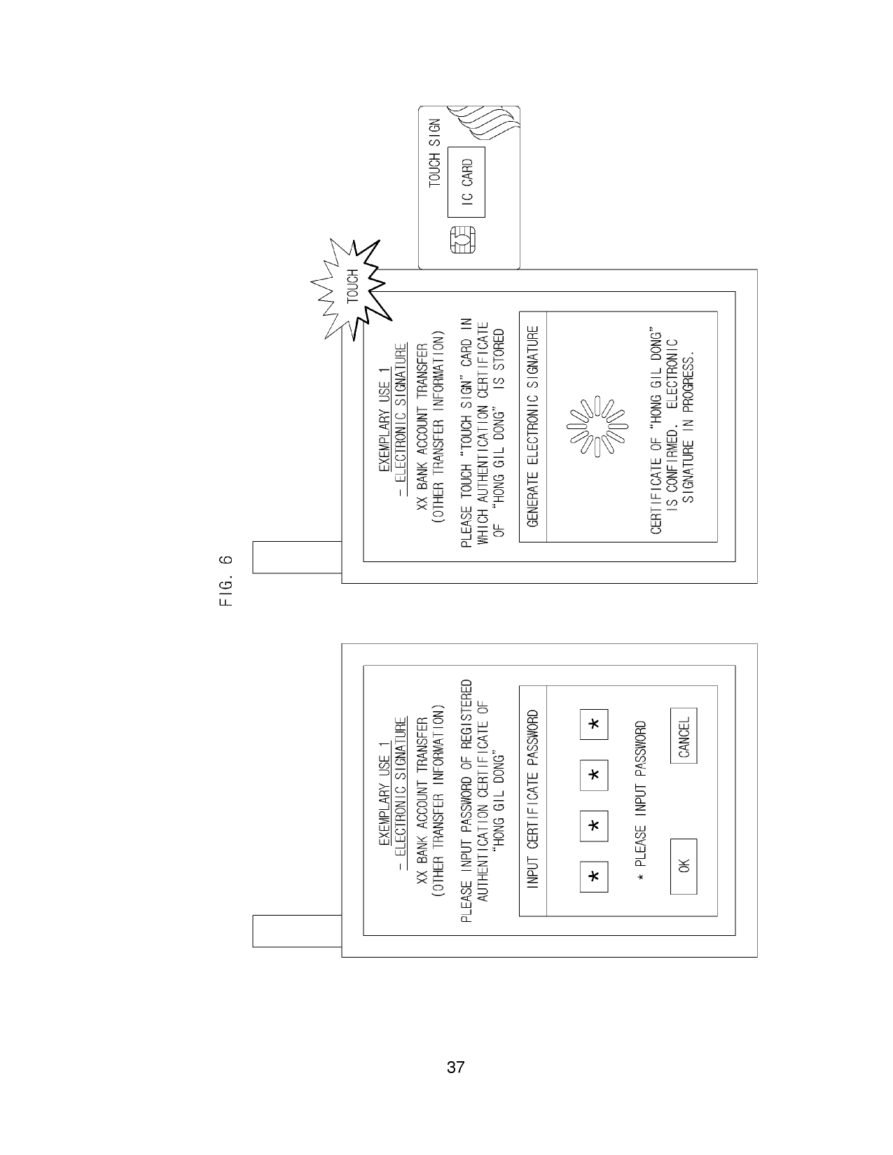

FIG. 6 illustrates an exemplary screenshot of electrically signing using an IC card according to an embodiment of the present invention. As illustrated in FIG. 6, the application may be mobile bank software. It is assumed that the IC card for providing the security service (for example, an electronic signature service for account transfer) is previously registered in the user terminal. In order to secure electronic signature data, the mobile bank software requests the user authentication information (for example, a certificate password) of the IC card in which an authentication certificate of “Hong Gil Dong” is stored. When the user inputs the user authentication information and clicks an OK button, the mobile bank software requests that the user touch the pre-registered IC card. When the user touché s the pre-registered IC card, the mobile bank software determines identification information of the IC card, performs user authentication, and then may perform the electronics signature. In this case, when the terminal authentication information is registered in the IC card, terminal authentication may be performed first before the electronic signature is performed.

In the above example, previously receiving the user authentication information of the authentication certificate of “Hong Gil Dong” and requesting that the IC card in which the authentication certificate is stored be touched are different from those of general authentication certificate use. In general authenticate-related software, authentication certificate data is secured from a terminal storage or a security token, owner information is extracted from the secured data is output on a screen. When the user checks the output owner information and inputs the user authentication information of the selected authentication certificate, an identity is confirmed through the input user authentication information and then the process advances to a procedure of performing the electronic signature. On the other hand, in the present invention, in consideration of a usage characteristic of the IC card (for example, a situation in which communication between the user terminal and the IC card is disconnected), an electronic signature procedure may be slightly modified such that a registered authentication certificate of the registered IC card is previously selected, the user authentication information is input, and then swiping of the registered IC card is requested.

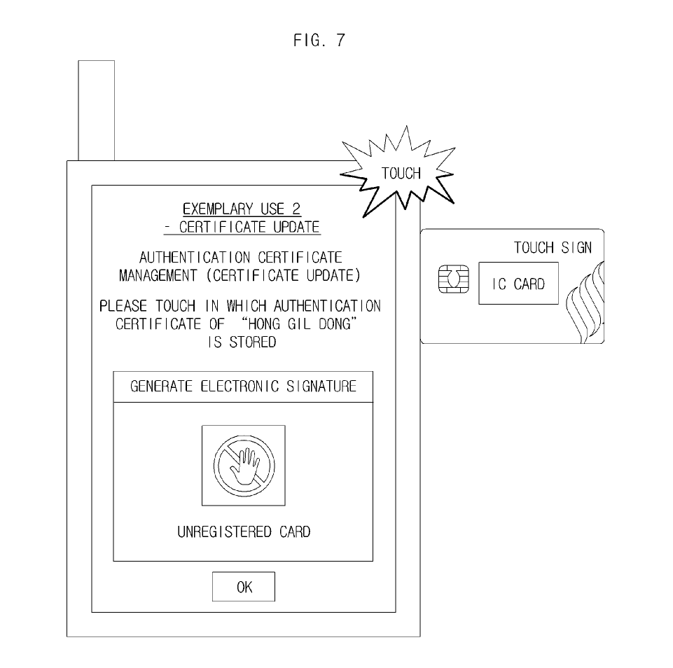

FIG. 7 illustrates an exemplary screenshot of a case in which update of a certificate previously stored in an IC card is failed according to an embodiment of the present invention. As illustrated in FIG. 7, the application may be authentication certificate management software. It is assumed that the IC card having an authentication certificate installed therein is previously registered in the user terminal and authentication certificate update is necessary. The authentication certificate management software secures the user authentication information and other data for authentication certificate update, outputs related content on a screen, and requests that the IC card in which an update target, the authentication certificate of “Hong Gil Dong,” is stored be touched. The user touched the IC card but the authenticate management software outputs that certificate update has failed on the screen. In this case, there are various reasons causing a failure of authenticate update, but the present invention has two main reasons. One reason is that the IC card touched by the user is an un-registered card as illustrated in the screen of FIG. 7. In other words, the authenticate management software expects the IC card in which the authentication certificate of “Hong Gil Dong” is stored but an IC card in which another authentication certificate is stored or a card unrelated to the authentication certificate is touched. The other reason is that, when terminal authentication is performed through the terminal authentication information registered when the IC card is registered, since another user terminal is used, terminal authentication performed in the IC card is failed.

The authentication certificate management software of the present invention may request that the IC card that can be registered to the software be brought in contact with the user terminal in order to issue or update the authentication certificate to the user through the screen of the user terminal. When the user brings an unregistered IC card in contact with the user terminal, the unregistered card is recognized through card identification information and a failure screen may be output. In addition, when the IC card performs authentication of the user terminal, if user terminal authentication information received from the user terminal is different from user terminal authentication information registered by the user terminal when the IC card is registered, a failure screen may be output.

While the above-described embodiments of the invention describe that all components are combined into one unit or are operated in a combined manner, the invention is not limited thereto. That is, within the scope of the invention, at least one of the components may be selectively combined and operated. Although all of the components may each be implemented as single independent hardware, some or all components may be selectively combined and implemented as a computer program having a program module that performs some or all functions combined in a single hardware device or a plurality of hardware devices. Such a computer program is stored in computer readable media such as a USB memory, a CD, or a flash memory, is read and executed by a computer, and thus may implement the embodiment of the invention. Examples of computer program recording media may include magnetic recording media, optical recording media, and carrier wave media.

The present invention provides a method capable of registering an IC card held by a user as a safe authentication medium through his or her terminal, and safely and conveniently using and managing authentication information such as an authentication certificate. When the IC card having the user's authentication certificate installed therein is registered and used through the user terminal without additional hardware, it is possible to provide a high level of security as in existing security tokens and provide a service at a low cost.

In addition, part of problems occurring when the IC card installed in the user terminal is used, for example, business constraints, constrains due to security issues, and the like, may be addressed.

Also, security information and the security service provided by the IC card may be restricted to be used in only the registered terminal of the user. Therefore, it is possible to correspond to risks such as unauthorized use and external attacks, and more safely use the security service such as the electronic signature.

Furthermore, when identification information and the like of the registered IC card is used, it is possible to optimize a procedure necessary for using the IC card and increase user convenience.

The above-described embodiments are only examples and it will be understood by those skilled in the art that various modifications and alternations may be made without departing from the spirit and scope of the invention. Therefore, the embodiments disclosed in this specification should be considered in a descriptive sense only and not for purposes of limitation. Accordingly, the scope of the invention is not limited by the embodiments. The scope of the invention is defined by the appended claims and encompasses all modifications and equivalents that fall within the scope of the appended claims.

What is claimed is:

1. An apparatus for using an IC card as an authentication medium, the apparatus comprising:
an ID extracting module configured to extract identification information from the IC card that performs near field communication with a user terminal;
an ID checking module configured to determine whether the extracted identification information matches identification information of the IC card that is previously registered as an authentication medium; and
a security service module configured to provide a security service interface for a security service provided by the determined IC card.

2. The apparatus of claim 1, wherein the ID extracting module includes identification information extracting command codes with respect to at least one specification of a plurality of standardized IC card specifications and private IC card specifications.

3. The apparatus of claim 2, wherein the ID extracting module determines whether the IC card is compliant with an IC card specification that can be used as the authentication medium, executes the identification information extracting command codes corresponding to the determined card specification, and extracts identification information from the IC card.

4. The apparatus of claim 1, wherein, when registration of the IC card as the authentication medium is requested from a user, the ID extracting module stores the extracted identification information in a memory of the user terminal or a secure element coupled to the user terminal.

5. The apparatus of claim 1, wherein, when registration of the IC card as the authentication medium is requested from a user, the ID extracting module delivers the extracted identification information to a card management server to be managed by the card management server.

6. The apparatus of claim 1, wherein, when use of a security service of the IC card is requested from a user, the ID checking module determines whether the extracted identification information matches identification information that is previously stored in a memory of the user terminal or a secure element coupled to the user terminal.

7. The apparatus of claim 1, wherein, when use of a security service of the IC card is requested from a user, the ID checking module delivers the extracted identification information or information generated using the extracted identification information to a card management server, and requests determination on whether the extracted identification information matches identification information that is previously stored in the card management server.

8. The apparatus of claim 1, further comprising:
a user authentication module configured to transmit user authentication information obtained from the user terminal to the IC card when user authentication is requested from the IC card.

9. The apparatus of claim 1, further comprising
a terminal authentication module configured to transmit terminal authentication information generated by the user terminal to the IC card when user terminal authentication is requested from the IC card.

10. An authentication system that uses an IC card as an authentication medium, the system comprising:
an IC card;
a user terminal configured to extract identification information from the IC card, register the IC card as an authentication medium, and use a security service provided by the registered IC card; and
a card management server configured to determine whether the IC card is registered as the authentication medium or the IC card is already registered as the authentication medium using identification information extracted from the IC card.

11. The authentication system of claim 10, wherein the user terminal includes:
a near field communicating unit configured to perform near field communication (NFC) with the IC card;
a memory configured to store an application program requiring the security service and an IC card manager program that provides the security service required by the application program using the IC card registered as the authentication medium; and
a processor configured to execute the application program and the IC card manager program stored in the memory,
wherein, when the IC card manager program is executed by the processor, the program causes the processor to extract identification information from the IC card, determine whether the extracted identification information matches identification information of the IC card that is previously registered as the authentication medium, and provide a security service interface for the security service provided by the determined IC card.

12. A method of using an IC card as an authentication medium, the method comprising:
requesting that a user bring an IC card to be registered as an authentication medium in contact with a user terminal;
determining whether the IC card in contact with the user terminal has an IC card specification that can be registered as the authentication medium;
extracting identification information from the IC card that has a registrable card specification by executing identification information extracting command codes corresponding to the IC card; and
storing the extracted identification information in either a memory of the user terminal or a secure element (SE) coupled to the user terminal, or transmitting the extracted identification information to a card management server to be stored in the card management server.

13. The method of claim 12, further comprising
transmitting terminal authentication information of the user terminal to the IC card to be stored in the IC card.

14. The method of claim 12, further comprising:
requesting that a user bring an IC card registered as the authentication medium in contact with the user terminal;
extracting identification information from the touched IC card by executing identification information extracting command codes corresponding to the registered IC card specification;
determining whether the extracted identification information matches identification information of the IC card that is previously registered as the authentication medium; and
using a security service provided by the determined IC card,
when the user wants to use the IC card registered as the authentication medium.

15. The method of claim 14, further comprising
transmitting terminal authentication information of the user terminal to the IC card when authentication of the user terminal is necessary to use the security service provided by the IC card.

16. The method of claim 14, further comprising
transmitting user authentication information of the user to the IC card when authentication of the user is necessary to use the security service provided by the IC card.
